(19) United States
(12) Patent Application Publication
(10) Pub. No.: US 2016/0008226 A1
(43) Pub. Date: Jan. 14, 2016

(54) CUSTOMIZABLE MEDICATION DISPENSER

(71) Applicants: Paul J. Hines, Ashland, WI (US); Steven Ryan Wesner, Maple Grove, MN (US)

(72) Inventors: Paul J. Hines, Ashland, WI (US); Steven Ryan Wesner, Maple Grove, MN (US)

(21) Appl. No.: 14/327,108

(22) Filed: Jul. 9, 2014

(51) Int. Cl. A61J 7/00

(52) U.S. Cl. CPC A61J 7/0076

(57) ABSTRACT

A device for dispensing medication includes a cassette having a first circular wall defining a center opening, a second circular wall disposed about the first circular wall, and a plurality of removable dividers extending between the first circular wall and the second circular wall. The first circular wall, the second circular wall, and the plurality of removable dividers define a row of compartments. A device for dispensing mediation also includes a base unit capable of receiving the cassette, an electronic core extending vertically from the base unit and capable of extending through the center opening of the cassette, and a lid attached to the base unit.

### BACKGROUND

The present invention relates generally to medical devices and, more particularly, to medical devices for storing and dispensing medication.

Medication dispensers can be used for allocating medication and monitoring medication intake. Medications can be allotted into the compartments of a medication dispenser, each compartment generally representing a discrete time point at which to take the medications. For example, the compartments could represent a day of the week on which to take the medications, or a time of day at which to take the medications. These compartments are typically rectangular or curved, depending on the overall shape of the medication dispenser. Specifically, rectangular dispensers typically have rectangular compartments, and circular dispensers typically have curved compartments. While rectangular compartments generally have the capacity to hold larger medications and larger doses, rectangular medical dispensers are bulkier and less portable. Circular medication dispensers, while generally more portable, cannot hold larger medications and doses due to their curved compartments. Increasing the radius of circular medication dispensers allows for larger curved compartments to accommodate larger medications and doses, but as the radius increases, the device loses portability.

One solution is to have neighboring compartments store medications for dispensing at the same time point. For example, patients with larger medication doses in the morning could have more than one compartment dispensed in the morning. However, this method increases the frequency at which the dispenser must be refilled. Another solution is to change the size of the compartments. However, larger medications can become stuck in the compartment if the compartment is too small, and larger compartments put users taking smaller pills at a disadvantage because they need to re-fill the dispenser more often than they would if they had a device with a greater number of smaller compartments. Another problem with both of these solutions is that many medication regimens can and often do change with some regularity over the course of a person's lifetime. A dispenser optimized for one regimen does not necessarily have the same advantages when used for a different regimen.

### SUMMARY

A device for dispensing medication includes a cassette having a first circular wall defining a center opening, a second circular wall disposed about the first circular wall, and a plurality of removable dividers extending between the first circular wall and the second circular wall, wherein the first circular wall, the second circular wall, and the plurality of removable dividers define a row of compartments. The device for dispensing mediation also includes a base unit capable of receiving the cassette, an electronic core extending vertically from the base unit and capable of extending through the center opening of the cassette, and a lid attached to the base unit.

A device for dispensing medication includes a base unit capable of receiving a cassette, the cassette having a first circular wall defining a center opening, a second circular wall disposed about the first circular wall. The first circular wall and the second circular wall define a row of compartments. The device for dispensing medication also includes a first compartment having a first volume, and a second compartment having a second volume, wherein the second volume is different than the first volume. The device for dispensing medication also includes an electronic core extending vertically from the base unit and capable of extending through the center opening of the cassette, and a lid attached to a top side of the base unit.

### BRIEF DESCRIPTION OF THE DRAWINGS

FIG. 1A is a perspective view of a medication dispenser with an inner window of an aperture partially open.

FIG. 1B is a perspective view of the medication dispenser with the inner window of the aperture fully open.

FIG. 2A is a perspective view of the medication dispenser with a cassette having removable dividers.

FIG. 2B is an exploded view of the medication dispenser with a cassette having removable dividers.

FIG. 3A is a perspective view of a base unit with an electronic core having a cassette guide.

FIG. 3B is a perspective view of the base unit showing the rotatable cassette guide of FIG. 3A.

FIG. 3C is a perspective view of the base unit showing a set of control gears of the electronic core.

FIG. 4A is a perspective view of a cassette with dividers.

FIG. 4B is a perspective view of the bottom of the cassette.

FIG. 4C is a perspective view of a cassette with some of the dividers removed.

FIG. 4D is a perspective view of a flexible projection having a flange associated with a removable divider.

FIG. 5A is a perspective view of a sliding door with a portion of the inner circle of the cassette accessible.

FIG. 5B is a perspective view of the sliding door of FIG. 5A rotated clockwise.

FIG. 5C is a perspective view of the sliding door of FIG. 5B rotated clockwise.

### DETAILED DESCRIPTION

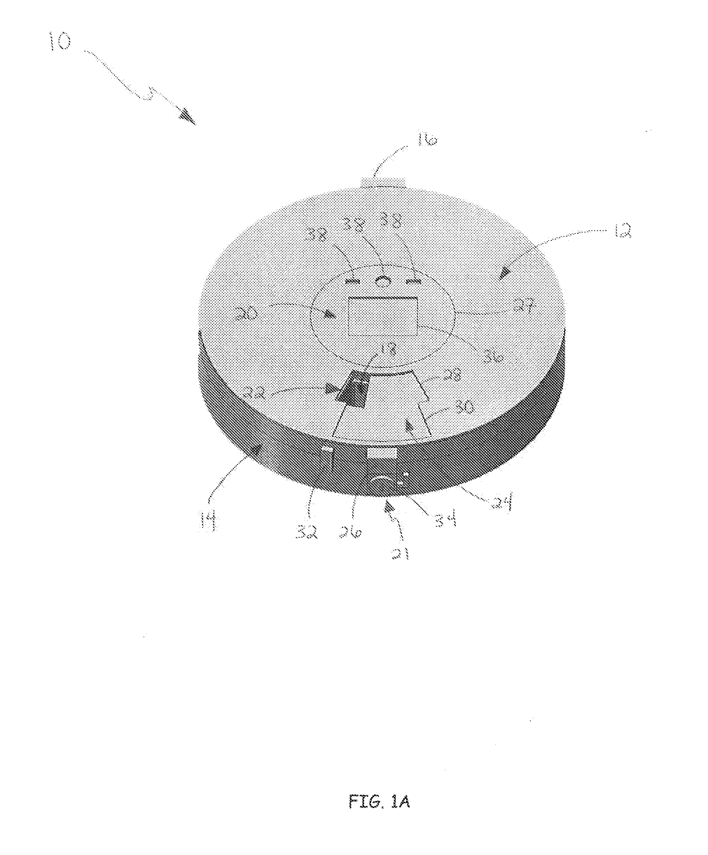

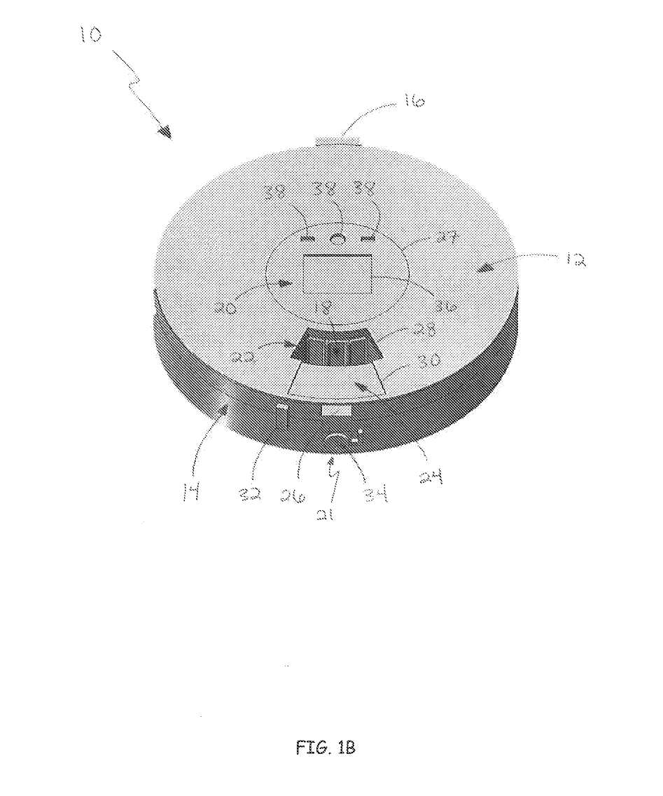

FIGS. 1A and 1B are perspective views of medication dispenser 10. Medication dispenser 10 includes lid 12, base unit 14, hinge 16, cassette 18, electronic core 20, and locking mechanism 21. Lid 12 includes aperture 22, sliding door 24, lid lock 26, and lid center opening 27. Aperture 22 is formed by inner window 28 and outer window 30. Base 14 includes outer divider sensor 32 and base lock 34. Electronic core 20 includes screen 36 and options buttons 38.

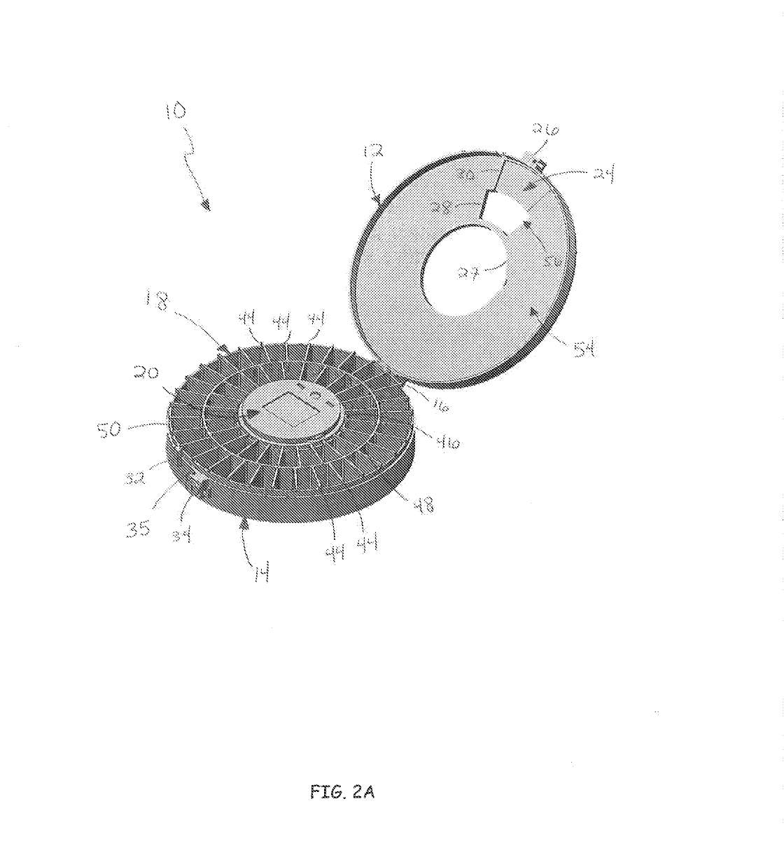

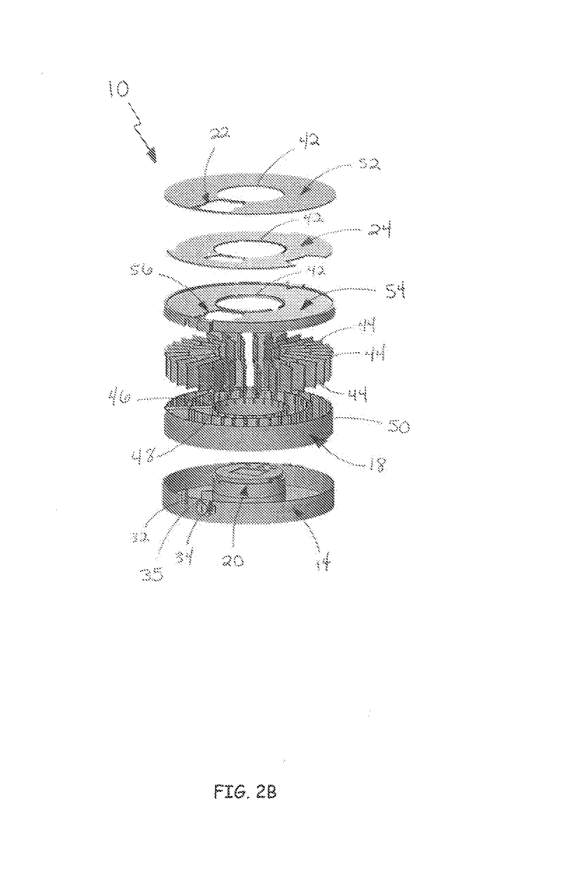

Lid 12 is connected to base unit 14 by hinge 16. Lid 12 can be opened to allow cassette 18 to be loaded into base unit 14. Electronic core 20 can extend vertically from base unit 14 such that a center opening in cassette 18 (not shown in FIG. 1) associates with electronic core 20 when cassette 18 is loaded into base unit 14. When lid 12 is closed, inner window 28 of aperture 22 can be directly above an inner row of compartments (not shown in FIG. 1) of cassette 18. When lid 12 is closed, outer window 30 of aperture 22 can be directly above an outer row of compartments (not shown in FIG. 1) of cassette 18. Sliding door 24 can rotate to open more or less of inner window 28 and outer window 30. In FIG. 1A, inner window 28 of aperture 22 is partially open, and in FIG. 1B, inner window 28 of aperture 22 is fully open. When lid 12 is closed, lid lock 26 associates with base lock 34 to form locking mechanism 21. In the embodiment shown in FIGS. 1A-1B, locking mechanism 21 is a latch and key lock. In alternate embodiments, locking mechanism 21 can lock lid 12 to base 14 by any suitable mechanism, such as a cam, switch, or padlock. In this manner, medication dispenser 10 can be loaded with cassette 18 and locked by locking mechanism 21. With sliding door 24 exposing only a portion of cassette 18 at a time, medication intake can be closely monitored and controlled. In the embodiment shown in FIGS. 1A and 1B, locking mechanism 21 also includes a sensor 35 (shown in FIG. 2), such as a photodiode, that can indicate when lid 12 is open and when it is closed and locked. In alternate embodiments, sensor 35 can be located at any position within medication dispenser 10 suitable for detecting the when lid 12 is in an open position or in a closed position, such as on electronic core 20.

When lid 12 is closed, lid center opening 27 surrounds electronic core 20. Electronic core 20 can serve as a user interface, with screen 36 displaying information such as medication dispense times and dates, and the medication to be dispensed. For example, screen 36 could display a picture of aspirin at the dispense date and time for an aspirin dose. Screen 36 could also display information such as device settings, reminder types, and reminder times. For example, screen 36 could also include a flashing light for a dispense time reminder. Electronic core 20 also has options buttons 38, which can control various functions of electronic core 20. Options buttons 38 can include an on/off switch, a switch to silence medication reminder alarms during travel, and a button for navigating options on screen 36. Options buttons 38 could also include navigation and selection buttons for a keypad displayed on screen 36, allowing users to change any number of settings on the device, including entering a PIN to access additional functions, manually overriding the device to dispense a medication prior to a scheduled time, locking the device, entering Wi-Fi credentials, and resetting the device. In the embodiment shown in FIGS. 1A-1B, options buttons 38 includes three buttons. In other embodiments, any number of buttons can be used to control the desired functions of the electronic core. Medication dispenser 10 can be web-enabled, such that patients, caregivers, and health care providers can monitor and/or control medication doses and intake. Medication dispenser 10 can be monitored and/or controlled via any number of network connections, including Internet, Bluetooth, Wi-Fi, radio frequency (RF), or cellular. For example, changing medication dispense times, dates, reminder settings, device refill times and reminders, manually overriding the device, and unlocking the device could all be performed remotely via web access.

FIG. 2A is a perspective view of medication dispenser 10 with cassette 18 having dividers 44. FIG. 2B is an exploded view of medication dispenser 10. Base 14 includes outer divider sensor 32. Cassette 18 includes dividers 44, inner (first) circular wall 46, intermediate (second) circular wall 48, and outer (third) circular wall 50. Lid 12 aperture 56, sliding door 24, lid center opening 27, top layer 52, and bottom layer 54.

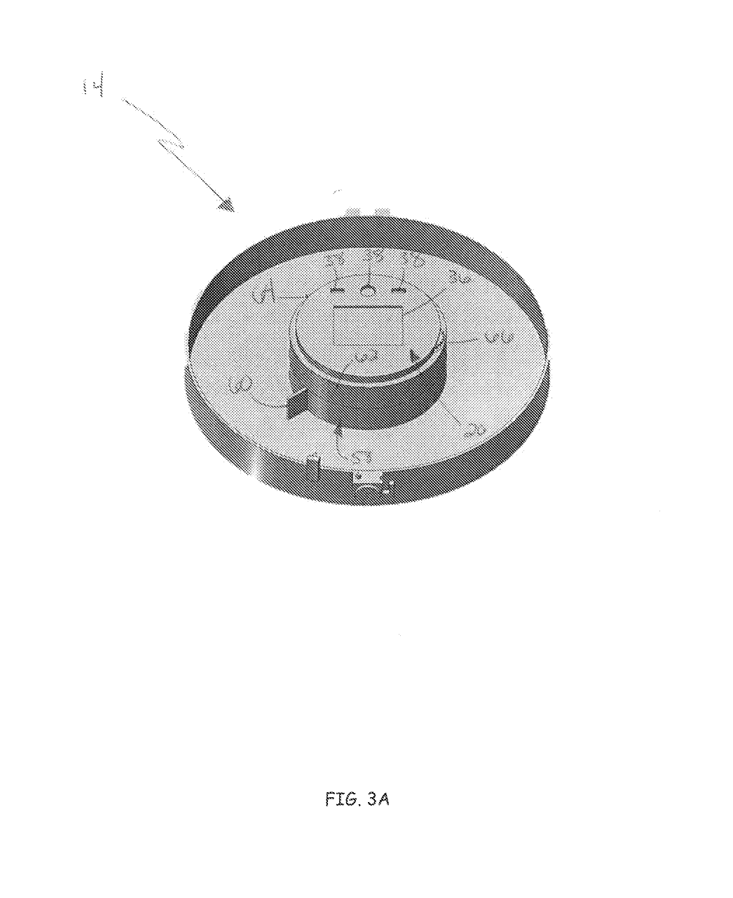

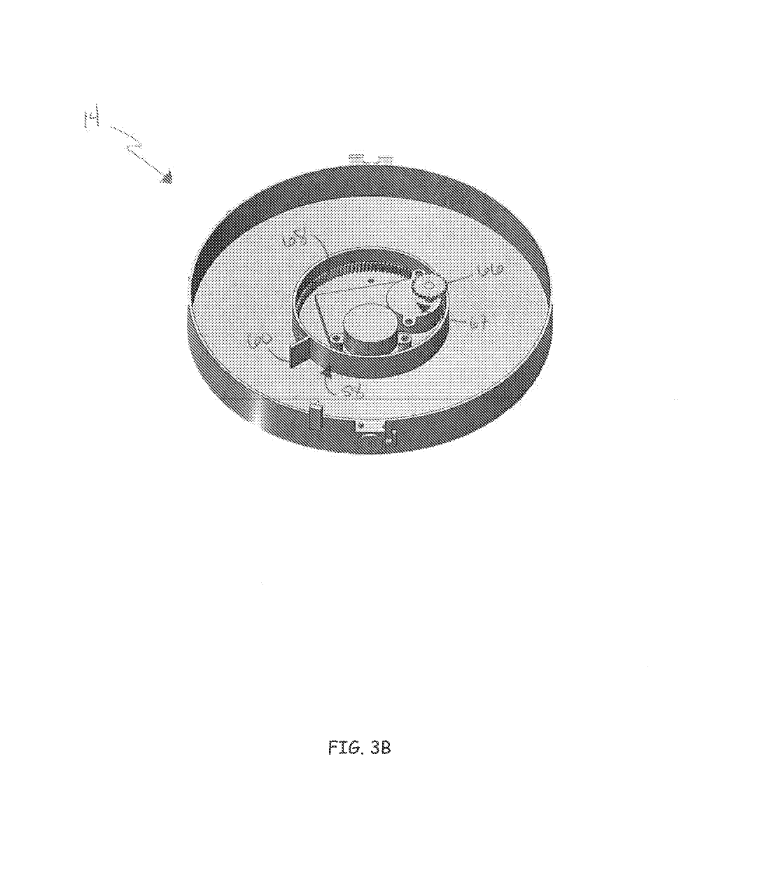

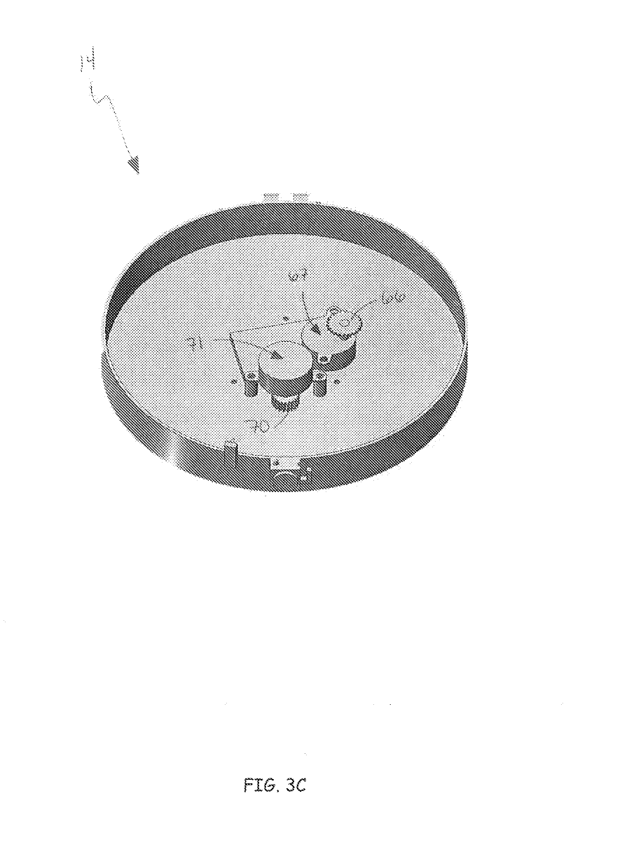

Base 14 is associated with electronic core 20. Electronic core 20 can be removable, as described in greater detail below. Cassette 18 can be loaded into base 14 such that inner circular wall 46 surrounds electronic core 20. Cassette 18 can include dividers 44. Dividers 44 can be secured within cassette 18 in any number of arrangements between inner circular wall 46 and intermediate circular wall 48, and between intermediate circular wall 48 and outer circular wall 50, as described in further detail below. In the embodiment shown in FIGS. 2A and 2B, cassette 18 includes intermediate circular wall 48, creating a plurality of rows of compartments between inner circular wall 46 and intermediate circular wall 48 and between intermediate circular wall 48 and outer circular wall 50. In alternate embodiments, cassette 18 could include inner circular wall 46 and outer circular wall 50 without intermediate circular wall 48, or cassette 18 could include multiple intermediate walls 48. Base 14 includes outer divider sensor 32 for sensing the location of dividers 44 between intermediate circular wall 48 and outer circular wall 50. Outer divider sensor 32 senses dividers 44 as dividers 44 pass by outer divider sensor 32. In the embodiment shown in FIGS. 2A-2B, outer divider sensor 32 is located on an outer wall of base 14. In alternate embodiments, outer divider sensor 32 can be located at any position within medication dispenser 10 suitable for detecting the location of dividers 44 located between intermediate circular wall 48 and outer circular wall 50. In the embodiment shown in FIGS. 2A-2B, sensor 32 is a mechanical sensor that contacts each of the dividers 44 as they pass. In alternate embodiments, sensor 32 could be any sensor suitable for detecting the position of dividers 44, such as a photodiode. Another divider sensor (sensor 64 shown in FIG. 3A) can be positioned at any location within medication dispenser 10 suitable for detecting the location of dividers 44 located between inner circular wall 46 and intermediate circular wall 48. Additional divider sensors can be positioned within medication dispenser 10 for detecting the location of dividers 44 located in additional rows of compartments defined by additional intermediate circular walls.

In the embodiment shown in FIGS. 2A and B, lid 12 can be formed from top layer 52 and bottom layer 54, with sliding door 24 between them. In alternate embodiments, lid 12 could have a single layer. For example, sliding door 24 could be attached to a single layer having a lip or other mechanism that would allow sliding door 24 to rotate while being held flush with the single layer. Top layer 52 has aperture 22, and bottom layer 54 has aperture 56. Aperture 22 and aperture 56 can be the same size. When lid 12 is closed, inner window 28 is positioned over the compartments formed by dividers 44 between inner circular wall 46 and intermediate circular wall 48. Similarly, when lid 12 is closed, outer window 30 is positioned over the compartments formed by dividers 44 between intermediate circular wall 48 and outer circular wall 50. In this manner, lid 12 can selectively expose a portion of cassette 18, as described in greater detail below.

FIG. 3A is a perspective view of base unit 14 with electronic core 20 and cassette guide 58. Electronic core 20 includes screen 36, options buttons 38, cassette guide 58, radial projection 60, inner divider sensor 62, sliding door sensor 64, and sliding door control gear 66. Cassette guide 58 can be flush with the exterior of electronic core 20. In the embodiment shown in FIGS. 3A-3B, cassette guide 58 is located at the bottom of electronic core 20. In alternate embodiments, cassette guide 58 can be located anywhere on electronic core 20 suitable for securing a cassette (not shown in FIGS. 3A-3C). Radial projection 60 is located on cassette guide 58, and can fit into a notch on cassette 18. In the embodiment shown in FIGS. 3A-3B, the rotation of the cassette is guided by radial projection 60 on cassette guide 58. In alternate embodiments, electronic core 20 can control rotation of the cassette by any mechanism suitable to secure and guide the rotation of the cassette. For example, cassette 18 could have a circular track of teeth that rests on a gear in base unit 12 that is controlled by electronic core 20.

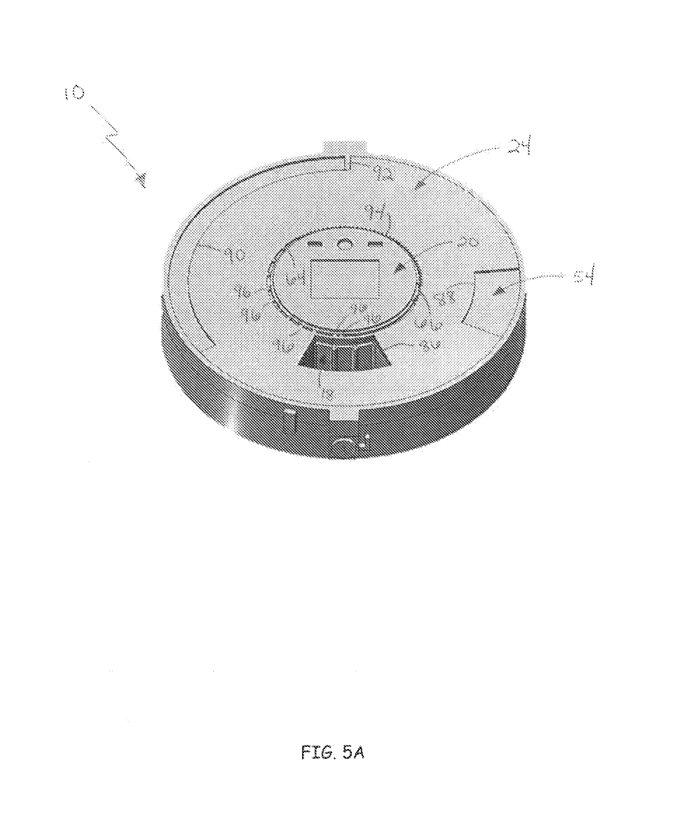

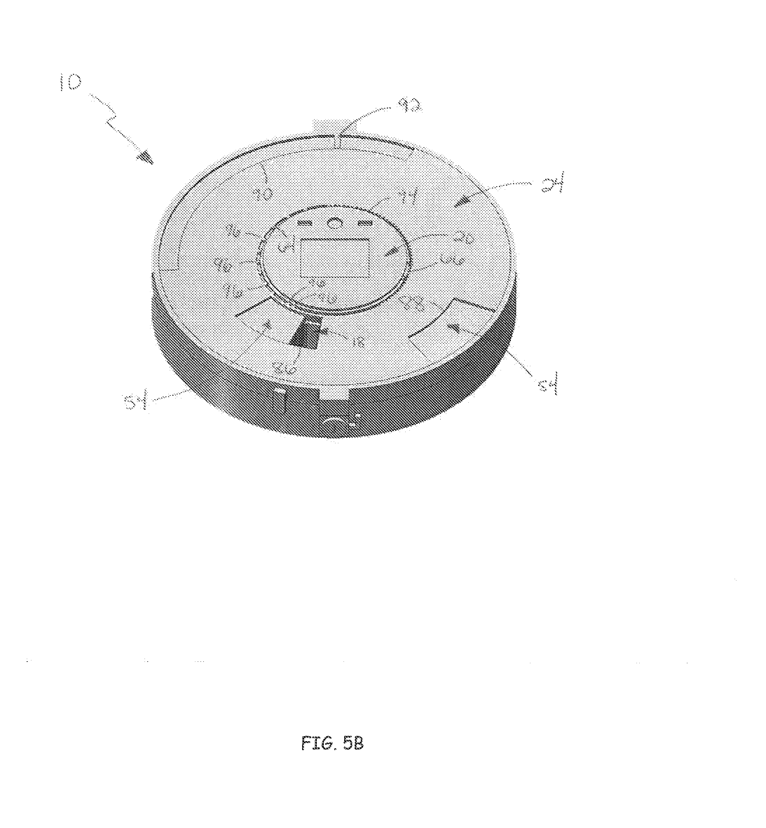

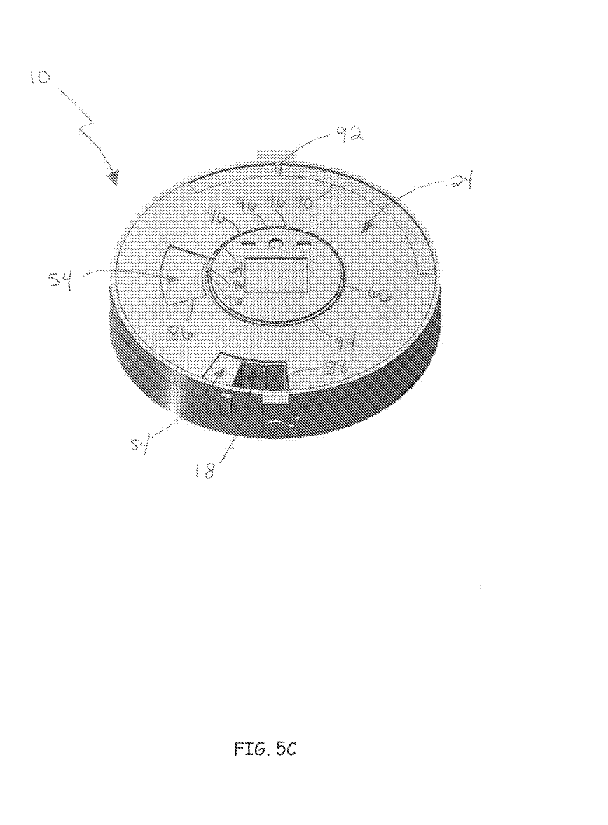

In the embodiment shown in FIG. 3A, inner divider sensor 62 is located on the exterior of electronic core 20. In alternate embodiments, inner divider sensor 62 can be located at any position within medication dispenser 10 suitable for detecting the location of dividers 44 (not shown in FIGS. 3A-3C) located between inner circular wall 46 and intermediate circular wall 48 of cassette 18 (not shown). Similarly, in the embodiment shown in FIG. 3A, sliding door sensor 64, described in detail in FIGS. 5A-5C, is located on the exterior of electronic core 20. In alternate embodiments, sliding door sensor 64 can be located at any position within medication dispenser 10 suitable for detecting the location of sliding door 24 (not shown in FIGS. 3A-3C).

In the embodiment shown in FIGS. 3A-3C, electronic core 20 extends vertically from base unit 14. In alternate embodiments, electronic core 20 can be removable from base unit 14 such that electronic core 20 can be secured in a different base unit having a larger or smaller size capable of holding a larger or smaller cassette. Electronic core 20 could be installed in the base unit having a larger or smaller size by any suitable means, including a latch, clip, or screw.

FIG. 3B is a perspective view of cassette guide 58. Electronic core 20 includes cassette guide 58, radial projection 60, notched ring 68, and sliding door control gear 66. Notched ring 68 can be located on the interior surface of cassette guide 58. A cassette guide control gear (shown in FIG. 3C) is positioned such that it contacts notched ring 68. Sliding door control gear 66 is positioned such that it protrudes from an opening in the exterior of electronic core 20 and contacts a toothed section located on sliding door 24 (shown in FIGS. 5A-5C).

FIG. 3C is a perspective view of sliding door control gear 66 and cassette guide control gear 70. Sliding door control gear 66 is rotated by electronic motor 67. The motion generated by the rotation of sliding door control gear 66 can be transferred sliding door 24 via a toothed section located on sliding door 24 (shown in FIGS. 5A-5C). In the embodiment shown in FIGS. 3A-3C, the rotation of the sliding door is guided by sliding door control gear 66 and the notched ring located on the sliding door. In alternate embodiments, electronic core 20 can control rotation of sliding door 24 by any suitable mechanism. For example, sliding door 24 could have a clip or latch configured to connect with a clip or latch located on electronic core 20.

Cassette guide control gear 70 is rotated by electronic motor 71. The motion generated by the rotation of cassette guide control gear 70 can be transferred to cassette guide 58 via notched ring 68. The rotation of cassette guide 58 in turn rotates cassette 18.

Electronic core 20 controls sliding door control gear 66 and cassette guide control gear 70 to regulate medication dispensing. When cassette 18 is placed within base unit 14, the electronic motor can rotate cassette 18 one full revolution such that inner divider sensor 62 and an outer divider sensor (not shown in FIGS. 3A-3B) can sense the location of dividers 44. The location of dividers 44 can then be stored within a memory of medication dispenser 10 and/or sent to the web. Alternatively, the location of dividers 44 can be stored and/or sent as cassette 18 rotates in the course of dispensing medication. Electronic core 20 can be programed to rotate cassette 18 remotely using the web, or manually using screen 36 and/or options buttons 38. Electronic core 20 can be programmed to rotate cassette 18 and sliding door 24 to preferred locations at preferred time points.

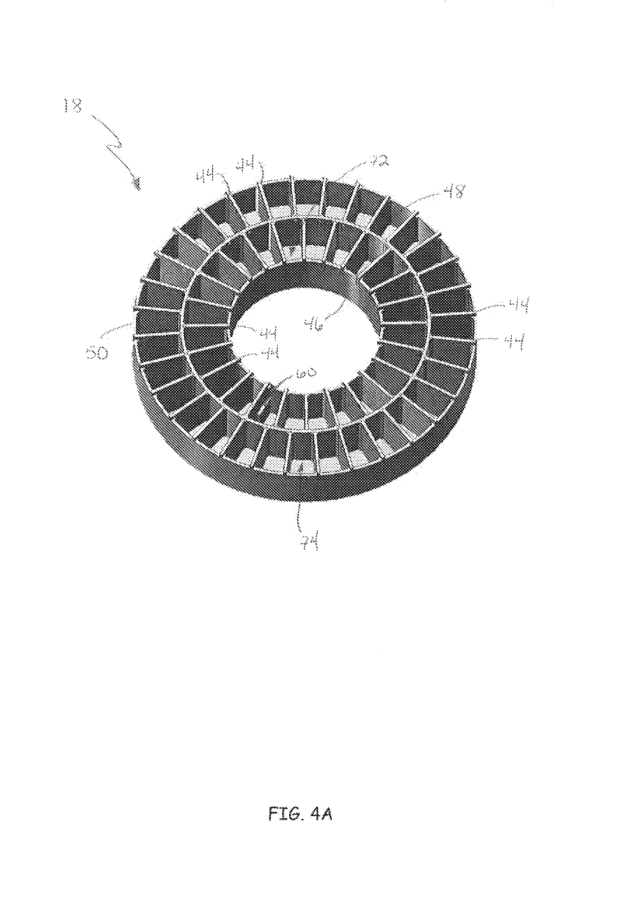

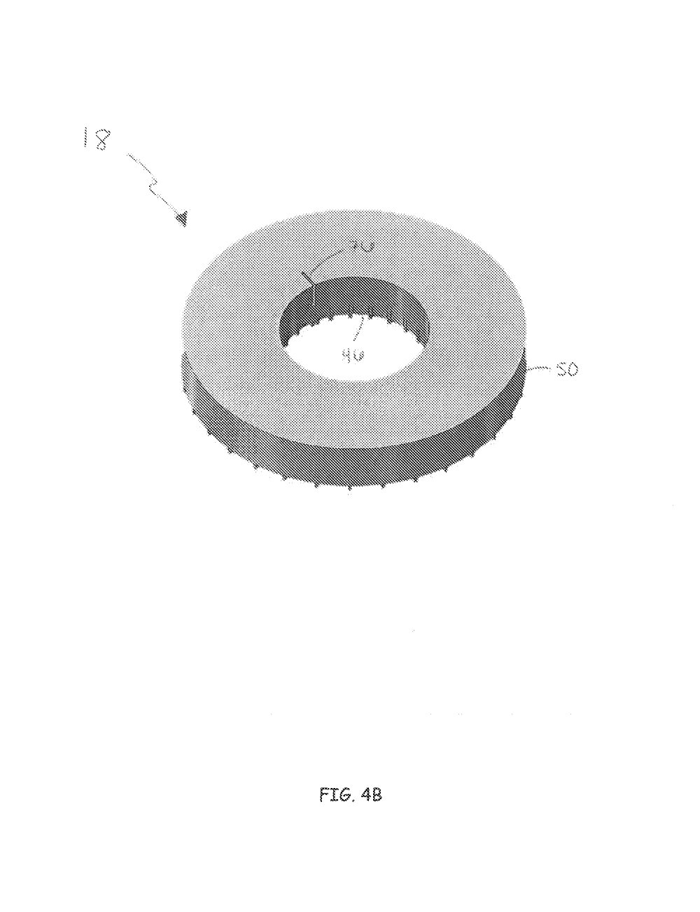

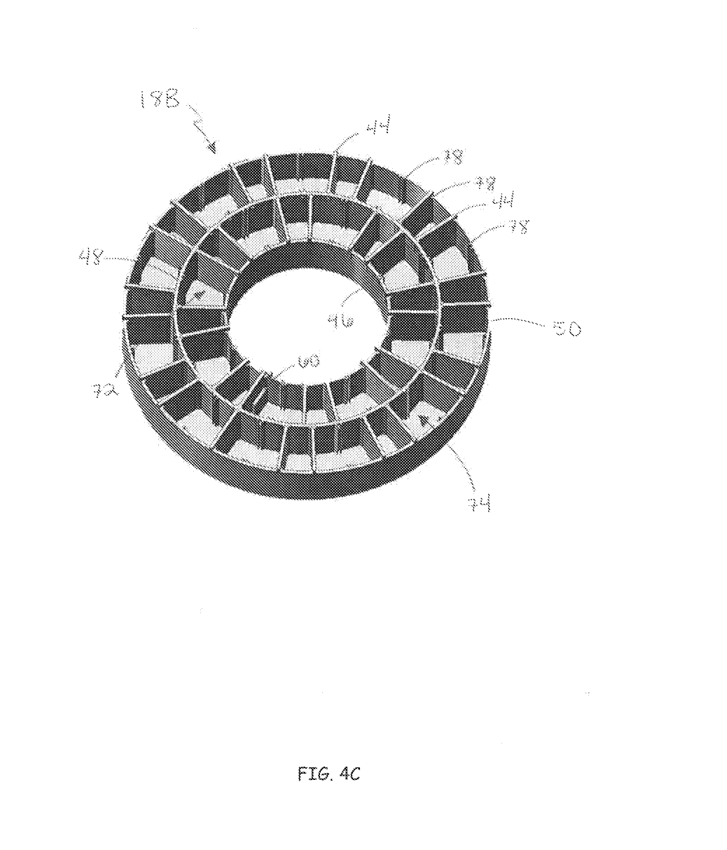

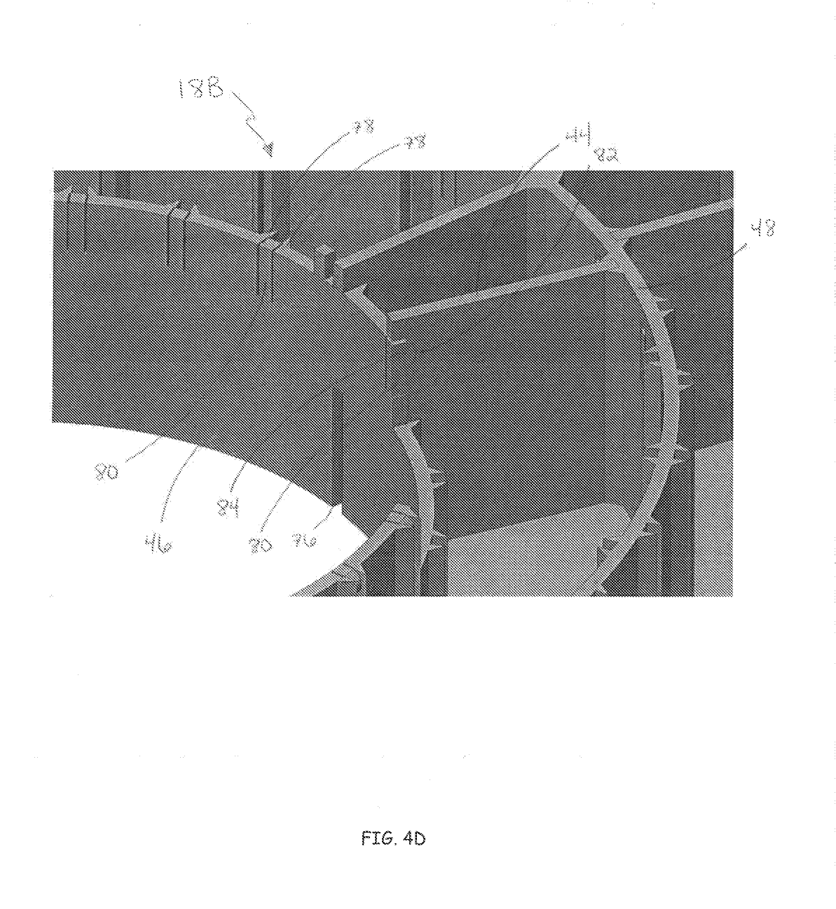

FIG. 4A is a perspective view of cassette 18 with dividers 44. Dividers 44 can be removable or fixed. FIG. 4B is a perspective view of the bottom of cassette 18. FIG. 4C is a perspective view of cassette 18B with some of dividers 44 removed. FIG. 4D is perspective view of flexible projection 80 having flange 84 associated with dividers 44, with a portion of inner circular wall 46 cut away to better show flange 84 associated with a divider 44.

Cassette 18 includes dividers 44 having notches 82, inner circular wall 46, intermediate circular wall 48, outer circular wall 50, inner row of compartments 72, outer row of compartments 74, notch 76 for receiving radial projection 60 of the cassette guide (not shown), divider guides 78, and flexible projections 80 having flanges 84.

Inner circular wall 46, intermediate circular wall 48, and dividers 44 define inner row of compartments 72. Intermediate circular wall 48, outer circular wall 50, and dividers 44 define outer row of compartments 74. In one embodiment, divider guides 78 line each side of inner row of compartments 72 and each side of outer row of compartments 74. Each pair of divider guides 78 is positioned across from another pair of divider guides. Flexible projections 80 can be located along inner circular wall 48. Each flexible projection 80 is located between two divider guides 78 along inner circular wall 48. In the embodiment shown in FIGS. 4A-4D, dividers 44 have notch 82, which connects with flange 84 of flexible projection 80. In alternate embodiments, dividers 44 could be secured simultaneously by a ring that has extensions corresponding to each of dividers 44. The ring could be secured to cassette 18 as a screw, with a loading position and a locked position. In the loading position, dividers 44 can be removed to define desired compartments. In the locked position, dividers 44 are secured to cassette 18.

Dividers 44 can be secured in cassette 18 in any number of arrangements suitable to accommodate a patient's medication regimen. For example, if larger pills, such as multivitamins or fish oil, are taken in the morning, dividers 44 can be spaced farther apart in cassette 18, forming a larger compartment to allow for a pill having a greater volume. Similarly, if smaller medications are taken later in the day, dividers 44 could be spaced closer together to form smaller compartments. For example, if a patient takes a smaller medication at three time points after the patient takes his or her morning medications, dividers 44 could form a larger compartment followed by three smaller compartments. If the patient's regimen changes such that larger pills are taken at various times through the day, dividers 44 can be rearranged to accommodate the new regimen.

In the embodiment shown in FIGS. 4A-4D, dividers 44 are selectively positionable. In alternate embodiments, cassette 18 could have a series of fixed dividers forming compartments of variable size in any number of arrangements suitable to accommodate a patient's medication regimen. For example, cassette 18 could have fixed dividers defining a compartment with a large volume to accommodate large medications. The compartment with the large volume could be located in outer row of compartments 74. Adjacent to the compartment with the large volume in outer row of compartments 74, cassette 18 could have fixed dividers defining a compartment with a small volume to accommodate small medications. The compartment with the large volume and the compartment with the small volume could also be located adjacent to each other in inner row of compartments 72. Cassette 18 could have any number and arrangement of compartments having different volumes. In each of these embodiments, cassette 18 is customizable to accommodate a particular medication regimen.

FIGS. 5A-5C are perspective views of sliding door 24 as it rotates clockwise. Medication dispenser 10 has sliding door 24, electronic core 20, bottom layer 54, sliding door sensor 64, sliding door control gear 66, and door guide 92. Sliding door 24 has inner row aperture 86, outer aperture 88, guide aperture 90, toothed section 94, and sensor notches 96.

Sliding door 24 is located between bottom layer 54 and top layer 52 of lid 12 (not shown in FIGS. 5A-5C). In the embodiment shown in FIGS. 5A-5C, sliding door sensor 64 is located on the exterior of electronic core 20 such that when sliding door control gear 66 transfers motion to sliding door 24 via notched section 94, sliding door sensor 64 detects the position of sliding door 24. In alternate embodiments, sliding door sensor 64 can be located at any position within medication dispenser 10 suitable for detecting the location of sliding door 24. Door guide 92 is a radial projection from bottom layer 54 that spans the width of guide aperture 90 to limit the rotation of sliding door 24. Inner row aperture 86 is located in sliding door 24 such that it spans a portion of the inner row of compartments of cassette 18. For example, in the embodiment shown in FIGS. 5A-5C, inner row aperture 86 exposes three segments defined by divider guides 78 of inner row of compartments 72. Outer row aperture 88 is located in sliding door 24 such that it spans a portion of the outer row of compartments of cassette 18. For example, in the embodiment shown in FIGS. 5A-5B, outer row aperture 88 exposes three segments defined by divider guides 78 of outer row of compartments 74.

Inner row aperture 86 and outer row aperture 88 can be spaced apart on sliding door 24 such that inner row of compartments 72 and outer row of compartments 74 of cassette 18 are not exposed at the same time. Sensor notches 96 are located next to electronic core 20 and are spaced at intervals equal to a desired rotation distance of sliding door 24. Two of the sensor notches 96 can be located closer together at a position representing the position of sliding door 24 when all apertures are completely covered. Sensor notches 96 pass by sliding door sensor 64 to signal the position of sliding door 24. In the embodiment shown in FIGS. 5A-5C, sliding door sensor 64 is a mechanical sensor that contacts each of the sensor notches 96 as they pass. In alternate embodiments, sensor 64 could be any sensor suitable for detecting the position of sensor notches 96, such as a photodiode. In the embodiment shown in FIGS. 5A-5B, sensor notches 96 are spaced such that one of the sensor notches 96 passing sliding door sensor 64 indicates sliding door 24 has rotated the equivalent of one segment defined by divider guides 78.

As electronic core 20 transfers movement to sliding door gear 66, sliding door gear 66 contacts notched section 94 to rotate sliding door 24 clockwise or counterclockwise. As sliding door 24 rotates, inner row aperture 86 and outer row aperture 88 can expose a desired portion of cassette 18 for retrieval of a medication dose. Movement of sliding door 24 is sensed by sliding door sensor 64 and sensor notches 96. Electronic core 20 stores and/or sends the sensed position of sliding door 24. In this manner, the portion of cassette 18 exposed by inner row aperture 86 or outer row aperture 88 can be closely monitored and controlled, such that the portion of cassette 18 exposed corresponds with the size of the compartment defined by dividers 44 for a particular dose.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device for dispensing medication, the device comprising:
a cassette comprising:
a first circular wall defining a center opening;
a second circular wall disposed about the first circular wall; and
a plurality of removable dividers extending between the first circular wall and the second circular wall, wherein the first circular wall, the second circular wall, and the plurality of removable dividers define a row of compartments;
a base unit configured to receive the cassette;
an electronic core extending vertically from the base unit and configured to extend through the center opening of the cassette; and
a lid attached to the base unit.

2. The device of claim 1, wherein the electronic core comprises a radial projection configured to associate with a notch on the cassette.

3. The device of claim 1, wherein the electronic core comprises a gear configured to associate with a notched ring located on an interior surface of the center opening of the cassette.

4. The device of claim 1, wherein the first circular wall and the second circular wall have a plurality of slots for receiving the plurality of dividers.

5. The device of claim 4, wherein the plurality of slots each have a first guide, a second guide, and a flexible projection located between the first guide and the second guide, and wherein the flexible projection has a flange located at an end of the flexible projection configured to associate with a notch in one of the plurality of dividers.

6. The device of claim 1, and further comprising:
a third circular wall disposed about the second circular wall; and
a second plurality of removable dividers extending between the second circular wall and the third circular wall, wherein the second circular wall, the third circular wall, and the second plurality of removable dividers define a second row of compartments.

7. The device of claim 1, wherein the lid comprises:
a cover layer having an aperture configured to span a portion of the row of compartments; and
a sliding door connected to the cover layer having an aperture configured to span a portion of the row of compartments such that the cover layer and the sliding door coordinate to expose a desired number of compartments.

8. The device of claim 7, wherein the electronic core comprises a gear configured to associate with a notched ring located on an interior surface of the sliding door.

9. The device of claim 7, wherein the electronic core comprises a first clip configured to associate with a second clip located on the sliding door.

10. The device of claim 7, and further comprising a plurality of sensors configured to detect the position of the sliding door and the positions of the plurality of dividers.

11. The device of claim 1, and further comprising a sensor configured to detect when the lid is in an open position and when the lid is in a closed position.

12. The device of claim 1, wherein the device is web-enabled to monitor and control device usage and settings.

13. The device of claim 1, wherein the electronic core is removable from the base unit.

14. A device for dispensing medication, the device comprising:
a base unit configured to receive a cassette, the cassette comprising
a first circular wall defining a center opening;
a second circular wall disposed about the first circular wall, wherein the first circular wall and the second circular wall define a row of compartments;
a first compartment having a first volume; and
a second compartment having a second volume, wherein the second volume is different than the first volume;
an electronic core extending vertically from the base unit and configured to extend through the center opening of the cassette;
a lid attached to a top side of the base unit.

15. The device of claim 14, wherein the electronic core is configured to control the rotation of the cassette.

16. The device of claim 14, and further comprising:
a third circular wall disposed about the second circular wall; and
a second plurality of removable dividers extending between the second circular wall and the third circular wall, wherein the second circular wall, the third circular wall, and the second plurality of removable dividers define a second row of compartments.

17. The device of claim 14, wherein the lid comprises:
a cover layer having an aperture configured to span a portion of the row of compartments; and
a sliding door connected to the cover layer having an aperture configured to span a portion of the row of compartments such that the cover layer and the sliding door coordinate to expose a desired number of compartments.

18. The device for dispensing medication of claim 17, wherein the electronic core comprises a gear configured to associate with a notched ring located on an interior surface of the sliding door.

19. The device of claim 18, and further comprising a plurality of sensors configured to detect the position of the sliding door and the positions of the plurality of dividers.

20. The device for dispensing medication of claim 14, wherein the device is web-enabled to monitor device usage.
